(19) United States
(12) Patent Application Publication
(10) Pub. No.: US 2025/0206421 A1
(43) Pub. Date: Jun. 26, 2025

(54) SAFETY SYSTEM FOR A MARINE VESSEL

(71) Applicant: Volvo Penta Corporation, GÖTEBORG (SE)

(72) Inventors: Johan Tell, Göteborg (SE); Lars Wik, Sävedalen (SE); Joakim Sällberg, Göteborg (SE); Björn Wessman, Torslanda (SE)

(21) Appl. No.: 18/987,294

(22) Filed: Dec. 19, 2024

(30) Foreign Application Priority Data
Dec. 22, 2023 (SE) 2351497-9

(51) Int. Cl. B63B 79/40; B63B 49/00; B63B 79/15

(52) U.S. Cl. CPC B63B 79/40; B63B 49/00; B63B 79/15

(57) ABSTRACT

A safety system for a marine vessel, the safety system comprising a plurality of proximity sensors, each proximity sensor having a detection zone and configured to detect objects within the detection zone; and a computer system comprising processing circuitry configured to trigger an action to stop rotation of the propeller in response to information from at least one of the plurality of proximity sensors indicating detection of an object within the detection zone of at least one of the plurality of proximity sensors. The plurality of proximity sensors arranged such that the detection zones of the plurality of proximity sensors enclose the propeller in a plane parallel to the longitudinal direction and the transversal direction.

### CROSS REFERENCE TO RELATED APPLICATION

This application claims foreign priority to Swedish Patent Application No. 2351497-9 filed on Dec. 22, 2023, the disclosure and content of which is incorporated by reference herein in its entirety.

### TECHNICAL FIELD

The disclosure relates generally to marine vessels. In particular aspects, the disclosure relates to a safety system for a marine vessel and a computer-implemented method of controlling the safety system. The disclosure also relates to a propeller assembly, and a marine vessel. The disclosure can be applied to marine vessels such as ships, boats, barges etcetera. Although the disclosure may be described with respect to a particular marine vessel, the disclosure is not restricted to any particular marine vessel.

### BACKGROUND

Participating in leisure activities like swimming or bathing often brings individuals close to marine vessels, posing a potential risk for boating accidents involving contact with rotating propellers. Moreover, in rescue operations amid turbulent waters, the potential entanglement of ropes in propellers may pose a significant hazard, potentially leading to operational interruptions of the marine vessel. This risk may escalate particularly in cases where the marine vessels are equipped with electric powertrains. The quieter operation of these vessels may make it challenging for the individuals to detect their presence, especially the submerged propellers, amplifying the danger.

Therefore, there is a strive to develop technology for increasing safety concerning marine vessels.

### SUMMARY

According to a first aspect of the disclosure, a safety system for a marine vessel according to claim 1 is provided. The marine vessel has a longitudinal extension in a longitudinal direction being parallel to an intended direction of travel of the marine vessel, the marine vessel further has a vertical extension in a vertical direction extending upwards perpendicular to a still water surface when the marine vessel is located in a body of water, the marine vessel also has a transversal extension in a transversal direction being perpendicular to each one of the longitudinal direction and the vertical direction. The marine vessel comprises at least one propeller arranged to rotate in the water to provide propelling force to the marine vessel during operation. The safety system comprises:
a plurality of proximity sensors, each proximity sensor having a detection zone and configured to detect objects within the detection zone; and
a computer system comprising processing circuitry configured to trigger an action to stop rotation of the propeller in response to information from at least one of the plurality of proximity sensors indicating detection of an object within the detection zone of at least one of the plurality of proximity sensors;
wherein the plurality of proximity sensors is arranged such that the detection zones of the plurality of proximity sensors enclose, preferably fully enclose, the propeller in a plane parallel to the longitudinal direction and the transversal direction.

The first aspect of the disclosure may seek to reduce the risk of boating accidents. A technical benefit, besides improved safety for individuals, such as water recreation participants, may include that a potential risk of damage of the marine vessel's components is reduced. The technical benefit is achieved by the arrangement of the proximity sensors which enables the detection zones to enclose, preferably fully enclose, the propeller as seen in a horizontally extending plane including at least a portion of the propeller. In this way, the system may detect objections from any direction relative to the propeller in a horizontal plane, establishing a protective boundary around the propeller. Moreover, by concentrating the detection zones around the propeller, the protection may be solely focused on the propeller, which may help in minimizing false alarms, reducing a risk of unnecessary stopping of the propeller. As a result, it may not only improve the safety level but may also improve operational efficiency of the marine vessel by preventing false alarms that may lead to unnecessary interruptions.

Optionally in some examples, including in at least one preferred example, each one of the detection zone has a conical shape extending between a sensor proximal end and a sensor distal end, wherein the plurality of proximity sensors is arranged such that the detection zones of the plurality of proximity sensors enclose, preferably fully enclose, the propeller in each plane, parallel to the longitudinal direction and the transversal direction, located at least from a lowermost point to a uppermost point of the propeller along the vertical direction. In this way, the detection zones may encompass at least every horizontal plane along a vertical extension of the propeller, thus providing a three-dimensional protective boundary. In some other examples, the detection zones may additionally enclose horizontal planes above the uppermost point or below the lowermost of the propeller. A technical benefit may include increased sensor coverage, leading to improved safety.

Optionally in some examples, including in at least one preferred example, the marine vessel further comprises a connecting member and a drive leg. The drive leg comprises a central axis extending between the connecting member and the propeller along the vertical direction. The plurality of proximity sensors is arranged about the central axis of the drive leg. By arranging the proximity sensors in this manner, it may be possible to concentrate the detection zones around the propeller. A technical benefit may include improved safety as well as improved operational efficiency of the marine vessel.

Optionally in some examples, including in at least one preferred example, in the plane parallel to the longitudinal direction and the transversal direction, the detection zones of the proximity sensors form a continuous area fully enclosing the propeller. The continuous detection zone may ensure that a risk of unmonitored area around the propeller is reduced. In some examples, there may be an overlap between two adjacent detection zones. This overlap may ensure that even if one sensor fails, the adjacent sensors may still maintain the coverage of the intended detection zone. A technical benefit may include reducing the risk of damage to the marine vessel's components due to undetected objects.

Optionally in some examples, including in at least one preferred example, the plurality of proximity sensors comprises at least four sensors located relative to the propeller such that lines connecting adjacent sensors enclose the propeller in the plane parallel to the longitudinal direction and the transversal direction. As such, it may create an efficient and reliable detection arrangement with reduced hardware complexity while ensuring full detection coverage.

Optionally in some examples, including in at least one preferred example, the safety system further comprises a safety mechanism configured to stop rotation of the propeller, wherein the processing circuitry is configured to cause the safety mechanism to stop rotation of the propeller in response to information from at least one of the plurality of proximity sensors indicating detection of an object within the detection zone of at least one of the plurality of proximity sensors. Purely by way of example, the safety mechanism may be a locking member which may lock a drive shaft on which the propeller is mounted. The safety mechanism may also be a mechanical brake configured for mechanically braking the propeller. This safety mechanism may act as an emergency mechanism for stopping the propeller in hazardous situations. A technical benefit may include increased reliability.

Optionally in some examples, including in at least one preferred example, the marine vessel comprises a power source for providing propulsion power to the propeller. The safety system comprises a power control device configured to control a power supply from the power source, or alternatively control a power transfer from the power source to the propeller via a transmission. Purely by way of example, the power source may comprise one or more electric motors, which may be understood as an electric engine. Alternatively, or additionally, the power source may comprise a combustion engine. In some examples, the power source may comprise a gas turbine. Irrespective of the type of power source, the power control device may be configured to control a power supply and/or power transfer to the propeller, thereby to enable and/or disable operation of the propeller. By properly operating the power control device, the propeller may be stopped at an appropriate moment. A technical benefit may include increased reliability.

Optionally in some examples, including in at least one preferred example, the plurality of proximity sensors comprises at least one of a sonar-based sensor, a radar-based sensor, a lidar-based sensor or a laser-based sensor. In general, sonar-based sensors may have great capability of underwater detection, which may allow for reliable detection of objects both above and beneath the water surface. Radar-based sensors may be relatively less costly and may operate effectively in various weather conditions, ensuring reliable performance regardless of environmental variables. In some examples, a sensor array may be formed by a combination of these sensors, which may mitigate individual sensor limitations and may enhance overall performance.

Optionally in some examples, including in at least one preferred example, the safety system further comprises:
a visual warning system configured to generate a visible indication at a warning zone being at a predetermined distance from the propeller, wherein the warning zone encloses, preferably fully enclose, the detection zones of the proximity sensors and the propeller in the plane parallel to the longitudinal direction and the transversal direction,
wherein the processing circuitry is further configured to cause the visual warning system to generate the visible indication during operation of the propeller.

The visual warning system may further increase a safety level as any nearby water recreation participants may be aware of the presence of the marine vessel with a spinning propeller. Moreover, by arranging the visible indication at the warning zone at a predetermined distance from the propeller, the chance of individuals approaching the detection zones may be reduced. As a result, the chance of triggering the propeller stop action may be lowered. A technical benefit may include improved operational efficiency of the marine vessel.

Optionally in some examples, including in at least one preferred example, the visual warning system comprises a bubble generator, wherein the bubble generator comprises:
an air pressurization device,
a plurality of air nozzles arranged at the warning zone, and
a guiding device for guiding pressurized air to the plurality of air nozzles.

Optionally in some examples, including in at least one preferred example, the processing circuitry is further configured to identify the detected object and determine whether the detected object is a forbidden object by inputting sensed data from the plurality of the proximity sensors to a machine-learning model. Herein, the forbidden object may be understood as any objects or obstacles that may cause boating accidents or may cause damage to the propeller, e.g., stuck in the propeller. As a contrast, a non-forbidden object may be anything that does not pose a risk of causing boating accidents or damage to the propeller, for instance, small floating debris. Using sonar-based sensors as an example, the sensed data may comprise returning echoes from objects detected inside the sensor's detection zones. Purely by way of example, the returning echoes, may comprise information such as shape of the echoes, amplitude of the echoes, or the frequency of the echoes, which may be input to the machine learning model. The model may then predict, preferably by classifying the detected object based on the input sensed data. By using a machine-learning model to determine whether the detected object is a forbidden object, a technical benefit may include unnecessary triggers of stopping the propeller due to detection of non-forbidden objects.

Optionally in some examples, including in at least one preferred example, the machine-learning model is trained using data collected by the plurality of the proximity sensors. For instance, these sensor data may be associated with a mix of forbidden objects and non-forbidden objects, where each data, comprising parameters of the returning echoes, is labelled with forbidden or non-forbidden object. In this way, the machine-learning model may be trained to classify the detected objects into correct categories.

According to a second aspect of the disclosure, a propeller assembly for a marine vessel is provided. The propeller assembly comprises a connecting member, a drive leg and the safety system according to the first aspect of the present disclosure. The drive leg comprises a central axis extending between the connecting member and the propeller along the vertical direction. The connecting member is configured to be articulately connected to a marine vessel's hull. Accordingly, the plurality of the proximity sensors is comprised in the propeller assembly. These sensors may be integrated during the propeller assembly process, precisely positioned and fine-tuned to desired angles to ensure the detection zones fully enclose the propeller both horizontally and vertically. As a result, the propeller assembly, with the plurality of proximity sensors, is ready for immediate installation on various marine vessels. A technical benefit may include enhanced flexibility.

Optionally in some examples, including in at least one preferred example, the connecting member has a horizontal extension in a connecting member plane being parallel to the longitudinal direction and the transversal direction, and wherein the propeller has a horizontal extension in a propeller plane parallel to the longitudinal direction and the transversal direction, wherein the horizontal extension of the connecting member is between 80%-150% of the horizontal extension of the propeller. By arranging the connecting member to have a horizontal extension that may substantially match or larger than the propeller's horizontal span, these sensors may be positioned at any suitable locations of the connecting member to create such detection zones that can enclose the propeller.

According to a third aspect of the disclosure, a marine vessel is provided. The marine vessel comprises a safety system according to the first aspect of the present disclosure, or a propeller assembly according to the second aspect of the present disclosure. Technical benefits of the third aspect of the disclosure are largely analogous to the technical benefit of the first aspect of the disclosure and/or the second aspect of the present disclosure.

According to a fourth aspect of the disclosure, a computer-implemented method for controlling a safety system according to the first aspect of the present disclosure. The method comprises:
obtaining, by the processing circuitry, information from at least one of the plurality of proximity sensors indicating detection of an object within the detection zone of at least one of the plurality of proximity sensors; and
in response thereto, triggering, by the processing circuitry, an action to stop rotation of the propeller.

The marine safety system may be exemplified by any of the above-described examples of the first aspect of the disclosure. Thus, advantages and advantageous features of the method appear from the above description of the safety system.

Optionally in some examples, including in at least one preferred example, the feature of triggering an action to stop rotation of the propeller comprises:
determining, by the processing circuitry, whether the detected object is a forbidden object using the machine learning model, and
initiating, by the processing circuitry, the action to stop rotation of the propeller in response to determining that the detected object is a forbidden object.

Optionally in some examples, including in at least one preferred example, the method further comprising:
in response to determining that the propeller starts to rotate, controlling, by the processing circuitry, the visual warning system to generate a visible indication at the warning zone.

According to a fifth aspect of the disclosure, a computer program product comprising program code for performing, when executed by the processing circuitry, the method according to the fourth aspect of the disclosure.

According to a sixth aspect of the disclosure, a non-transitory computer-readable storage medium is provided. The non-transitory computer-readable storage medium comprises instructions, which when executed by the processing circuitry, cause the processing circuitry to perform the method according to the fourth aspect of the disclosure.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

Examples are described in more detail below with reference to the appended drawings.

FIG. 1 is an exemplary perspective view of a marine vessel according to an example.

FIG. 2 is a schematic diagram illustrating a safety system for a marine vessel.

FIG. 3a and FIG. 3b are examples of a propeller assembly comprising a plurality of proximity sensors.

FIG. 3c and FIG. 3d are top views showing detection zones of the proximity sensors in relation to the propeller.

FIG. 4 illustrates a marine vessel comprising a visual warning system.

FIG. 5 is a schematic diagram illustrating the visual warning system.

FIG. 6 is a flow chart illustrating a method for controlling a safety system.

### DETAILED DESCRIPTION

The detailed description set forth below provides information and examples of the disclosed technology with sufficient detail to enable those skilled in the art to practice the disclosure.

Participating in leisure activities like swimming or bathing often brings individuals close to marine vessels, posing a potential risk for boating accidents involving contact with rotating propellers. This risk may escalate particularly in cases where the marine vessels are equipped with electric powertrains. The quieter operation of these vessels may make it challenging for the individuals to detect their presence, especially the submerged propellers, amplifying the danger. The present disclosure may seek to reduce the risk of boating accidents. A technical benefit, besides improved safety for individuals, such as water recreation participants, may include that a potential risk of damage of the marine vessel's components is reduced.

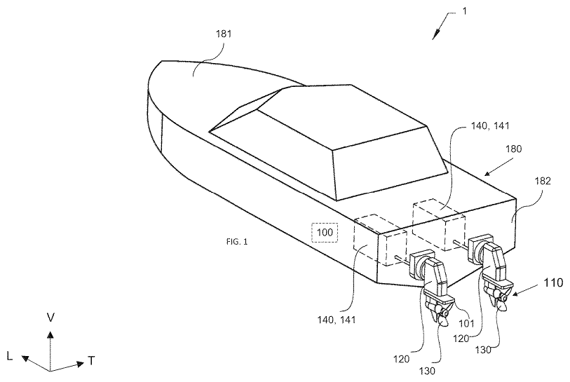

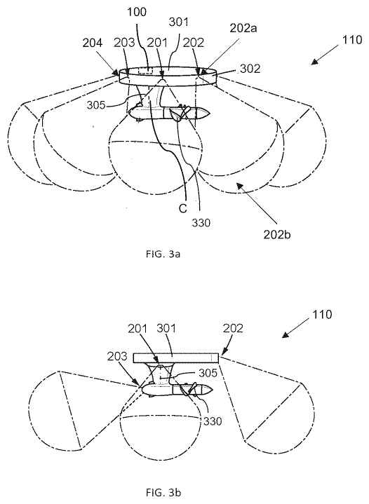

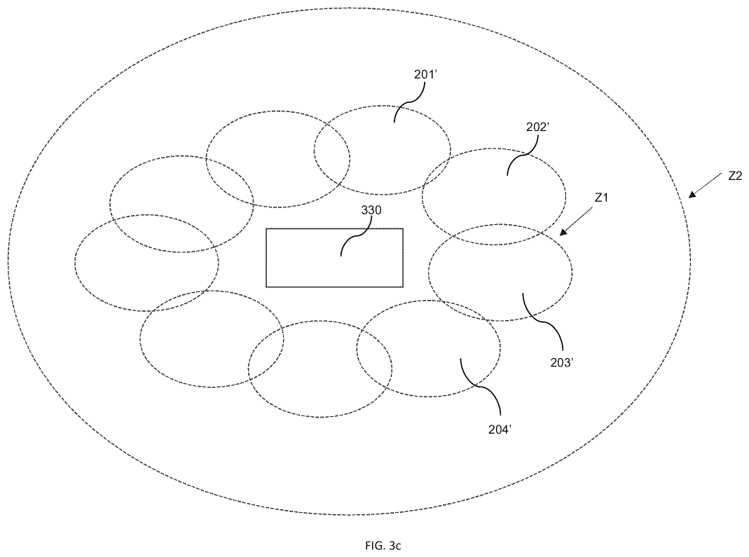

FIG. 1 is an exemplary schematic marine vessel 1. The FIG. 1 marine vessel 1 is exemplified as a boat. However, the marine vessel 10 may also be a ship, a barge or any other type of water vehicle. The marine vessel 1 has a longitudinal extension in a longitudinal direction L being parallel to an intended direction of travel of the marine vessel 1, a vertical extension in a vertical direction V extending upwards perpendicular to a still water surface when the marine vessel 1 is located in a body of water, and a transversal extension in a transversal direction T being perpendicular to each one of the longitudinal direction L and the vertical direction V. In the shown example, the marine vessel 1 comprises a hull 180 including a front end 181 and a rear end 182, whereby two propeller assemblies 110 are arranged at the rear end 182 of the hull 180. In the shown example, each propeller assembly 110 comprises a propeller 130 arranged to rotate in the water to provide propelling force to the marine vessel 1 during operation. The marine vessel 1 further comprises a power source 140 for providing propulsion power to the propeller 130 via a transmission 120. Purely by way of example, the power source 140 may comprise one or more electric motors, which may also be referred to as an electric engine. Alternatively, or additionally, the power source 140 may comprise an internal combustion engine. In some examples, the power source 140 comprises a gas turbine. Moreover, the propeller assembly 110 comprises a connecting member 101 and a drive leg 305 (see FIGS. 3a-3b), whereby the drive leg 305 comprises a central axis extending between the connecting member 101 and the propeller 130 along the vertical direction V. Details about propeller assembly 110 will be provided in the discussion of FIGS. 3a-3b. In the FIG. 1 example, the connecting member 101 is connected to the transmission 120 from below, while in some other examples, the connecting member 101 may be arranged to be articulately connected to a marine vessel's hull. Moreover, the marine vessel 1 comprises a safety system 100 for improving safety levels in the marine environment.

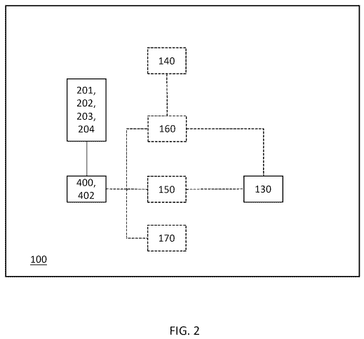

FIG. 2 is a schematic diagram illustrating the safety system 100. The safety system 100 comprises a plurality of proximity sensors 201, 202, 203, 204, such as the proximity sensors 201, 202, 203, 204 shown in FIG. 3a and FIG. 3b. Purely by way of example, the sensors may comprise at least one of a sonar-based sensor, a radar-based sensor, a lidar-based sensor or a laser-based sensor. Each proximity sensor 201, 202, 203, 204 has a detection zone and configured to detect objects within the detection zone. The proximity sensors 201, 202, 203, 204 are arranged such that the detection zones of the plurality of proximity sensors 201, 202, 203, 204 enclose, preferably fully enclose, the propeller 130 in a plane parallel to the longitudinal direction and the transversal direction. The safety system 100 further comprises a computer system 400 which may in turn comprises processing circuitry 402, configured to trigger an action to stop rotation of the propeller 130, in response to receiving information from at least one of the plurality of proximity sensors 201, 202, 203, 204 indicating detection of an object within the detection zone of at least one of the plurality of proximity sensors 201, 202, 203, 204.

FIG. 3a and FIG. 3b show two examples of the arrangement of the plurality of the proximity sensors 201, 202, 203, 204. Each one of FIG. 3a and FIG. 3b illustrates the examples where the proximity sensors 201, 202, 203, 204 are comprised in a propeller assembly 110. As shown in the figures and discussed above, the propeller assembly 110 comprises a connecting member 301 and a drive leg 305, whereby the drive leg 305 comprises a central axis C extending between the connecting member 301 and the propeller 330 along the vertical direction V. Moreover, each proximity sensor 201, 202, 203, 204 has a detection zone that has a conical shape extending between a sensor proximal end 202a and a sensor distal end 202b. The proximity sensors 201, 202, 203, 204 are arranged about the central axis of the drive leg 305. As such, the detection zones of proximity sensor 201, 202, 203, 204, enclose, preferably fully enclose, the propeller 330 in a plane parallel to the longitudinal direction and the transversal direction. Additionally, the detection zones enclose each one of the planes parallel to the longitudinal direction and the transversal direction, from a lowermost to an uppermost point of the propeller 330 along the vertical direction. In this way, the detection zones may encompass at least every horizontal plane along a vertical extension of the propeller 330, providing a three-dimensional protective boundary around the propeller 330. Furthermore, the FIG. 3a example shows that the detection zones also additionally enclose horizontal planes above the uppermost point, extending from the connecting member 301, as well as below the lowermost of the propeller 330. This may ensure even wider coverage, enhancing the safety and operational reliability of the propeller 330.

FIG. 3c is a top view showing detection zones of the proximity sensors in relation to the propeller, according to the FIG. 3a example. In the FIG. 3a example, the connecting member 301 has a horizontal extension in a connecting member plane being parallel to the longitudinal direction and the transversal direction, and the propeller 330 has a horizontal extension in a propeller plane parallel to the longitudinal direction and the transversal direction, respectively. Preferably, the horizontal extension of the connecting member 301 is between 80%-150% of the horizontal extension of the propeller 330. This may allow that when the proximity sensors are arranged along an outer perimeter edge 302 of the connecting member 301, as presented in FIG. 3a, the detection zones of the proximity sensors 201, 202, 203, 204 may form a continuous area Z1 fully enclosing the propeller 130, 330, as presented in FIG. 3c. The continuous detection area Z1 may ensure that a risk of unmonitored area is reduced. Moreover, as illustrated by the figure, there are overlaps between two adjacent detection zones, which may ensure that even if one sensor fails, other sensors may still maintain the intended detection coverage.

FIG. 3d is a top view showing detection zones of the proximity sensors in relation to the propeller, according to the FIG. 3b example. In the FIG. 3b example, the plurality of proximity sensors 201, 202, 203, 204 comprises at least four sensors, located relative to the propeller 330. Although the fourth sensor is not explicitly shown in FIG. 3b, FIG. 3d provides a top view illustrating that the at least four proximity sensors 201, 202, 203, 204 are arranged such that lines L1, L2, L3, L4 connecting adjacent sensors enclose the propeller 330 in the plane parallel to the longitudinal direction and the transversal direction.

In some examples, the safety system 100 is integrated in the propeller assembly 110. In other words, the propeller assembly 110 may additionally comprise the computer system 400 and/or the processing circuitry 402. As such, the safety system 100 including the plurality of the proximity sensors 201, 202, 203, 204 may be integrated during the assembly of the propeller. These sensors may be precisely positioned, and fine-tuned to desired angles, so as to ensure that the detection zones of the plurality of proximity sensors enclose, preferably fully enclose, the propeller horizontally and vertically. As a result, the propeller assembly 110 may be well prepared beforehand, ensuring readiness prior to mounting onto various marine vessels.

Turning back to FIG. 2, the safety system 100 may further comprise a safety mechanism 150 configured to stop rotation of the propeller 130, 330. For instance, the processing circuitry 402 may be configured to cause the safety mechanism 150 to stop rotation of the propeller 130, 330 in response to information from at least one of the plurality of proximity sensors 201, 202, 203, 204 indicating detection of an object within the detection zone of at least one of the plurality of proximity sensors 201, 202, 203, 204. The safety mechanism 150 may mechanically stop rotation of the propeller 130. Purely by way of example, the safety mechanism 150 may be a locking member which may lock a drive shaft in which the propeller is located. As another non-limiting example, the safety mechanism 150 may be a mechanical brake configured to mechanically brake propeller 130 330. Additionally, or alternatively, the safety system 100 may further comprise a power control device 160 configured to control a power supply to the power source 140 or to control a power transfer from the power source 140 to the propeller 330 via the transmission 120. The power control device 160 may selectively enable or disable the power supply from the power source 140 to the propeller 130, or to selectively enable or disable the power transfer from the power source 140 to the propeller 130 via the transmission 120.

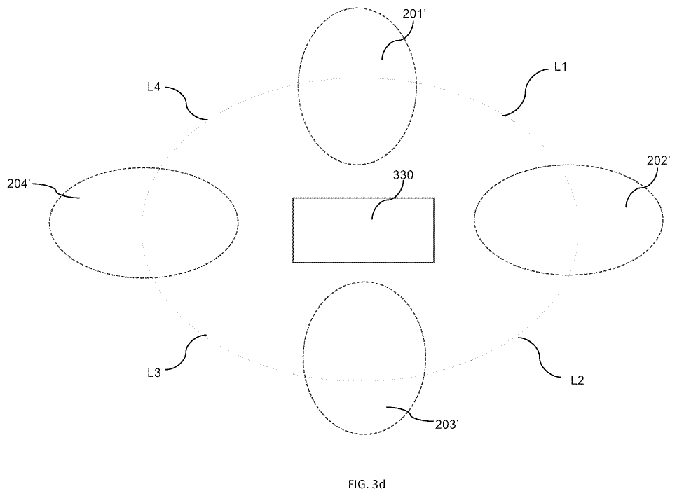

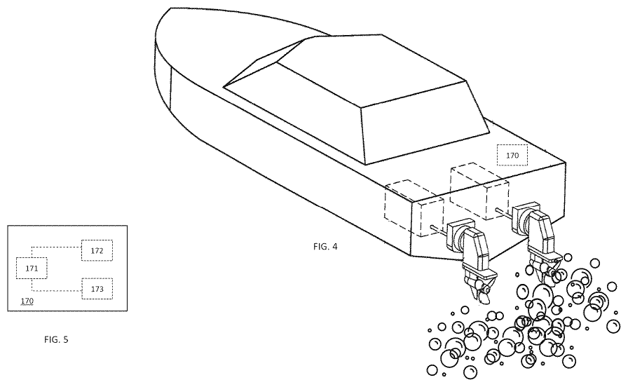

Moreover, the safety system 100 may comprise a visual warning system 170 configured to generate a visible indication at a warning zone Z2 being at a predetermined distance from the propeller 130, 330. The warning zone Z2 may enclose, preferably fully enclose, the detection zones Z1 of the proximity sensors 201, 202, 203, 204 and the propeller 130, 330 in the plane parallel to the longitudinal direction and the transversal direction, as presented in FIG. 3a. The processing circuitry 402 may be further configured to cause the visual warning system 170 to generate the visible indication during operation of the propeller 130, 330. As such, any nearby water recreation participants may be aware of the presence of the marine vessel with a spinning propeller, the chance of individuals approaching the detection zones Z1 may therefore be reduced. Accordingly, the chance of triggering the propeller stop action may be lowered. FIG. 4 illustrates an example of a marine vessel with visual warning generated around the propeller. In this example, the visual warning system 170 comprises a bubble generator 171, which in turn comprises an air pressurization device, a plurality of air nozzles arranged at the warning zone Z2, and a guiding device for guiding pressurized air to the plurality of air nozzles. Moreover, in some examples as illustrated by FIG. 5, the visual warning system 170 may additionally comprise a light emitting device 172 for emitting visible light and/or a coloring device 173 for expelling color substances, as a visual warning signal. The light emitting device 172 and/or the coloring device 173 may also be connected to the bubble generator 171 to add colors and/or light to the generated bubbles.

In some examples, the processing circuitry 402 is further configured to identify the detected object and determine whether the detected object is a forbidden object by inputting sensed data from the plurality of the proximity sensors 201, 202, 203, 204 to a machine-learning model. Herein, the forbidden object may be understood as any objects or obstacles that may cause boating accidents or may cause damage to the propeller, e.g., stuck in the propeller. As a contrast, a non-forbidden object may be anything that does not pose a risk of causing boating accidents or damage to the propeller, for instance, small floating debris. Using sonar-based sensors as an example, the sensed data may comprise returning echoes from objects detected inside the sensor's detection zones. Purely by way of example, the echoes, may comprise information such as shape of the echoes, amplitude, or the frequency of the echoes, which may be input to the machine learning model. The model may then predict, preferably by classifying the detected object based on the input data, distinguishing between various types of objects. In these examples, the machine-learning model may be trained using data collected by the plurality of the proximity sensors 201, 202, 203, 204. For instance, these sensor data may be associated with a mix of forbidden objects and non-forbidden objects, where each data, comprising parameters of the returning echoes, is labelled with forbidden or non-forbidden object. In this way, the machine-learning model may be trained to classify the detected objects into correct categories.

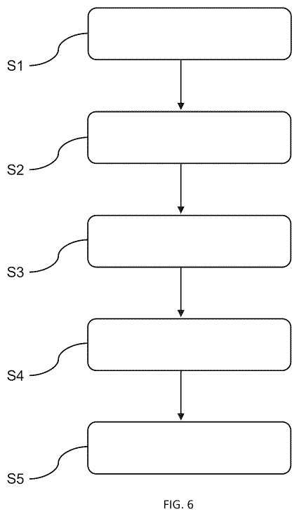

FIG. 6 is a flow chart illustrating a method for controlling the safety system 100. The method is performed by processing circuitry of the computer system 400 and comprises the actions listed in the following, which, unless otherwise indicated, may be taken in any suitable order.

S1: obtaining information from at least one of the plurality of proximity sensors 201, 202, 203, 204 indicating detection of an object within the detection zone of at least one of the plurality of proximity sensors 201, 202, 203, 204, and

S2: in response thereto, triggering an action to stop rotation of the propeller 130, 330.

In some examples, the method may further comprise:

S3: determining whether the detected object is a forbidden object using the machine learning model, and

S4: initiating the action to stop rotation of the propeller 130, 330 in response to determining that the detected object is a forbidden object.

In the examples where the safety system comprises the visual warning system 170, the method may further comprise:

S5: in response to determining that the propeller 130, 330 starts to rotate, controlling the visual warning system 170 to generate a visible indication at the warning zone Z2.

Moreover, the present disclosure may be exemplified by any one of the below examples and combination of examples.

Example 1: A safety system (100) for a marine vessel (1), the marine vessel (1) having a longitudinal extension in a longitudinal direction being parallel to an intended direction of travel of the marine vessel (1), the marine vessel (1) further having a vertical extension in a vertical direction extending upwards perpendicular to a still water surface when the marine vessel (1) is located in a body of water, the marine vessel (1) also having a transversal extension in a transversal direction being perpendicular to each one of the longitudinal direction and the vertical direction, the marine vessel (1) comprising at least one propeller (130, 330) arranged to rotate in the water to provide propelling force to the marine vessel (1) during operation, the safety system (100) comprising:
a plurality of proximity sensors (201, 202, 203, 204), each proximity sensor (201, 202, 203, 204) having a detection zone and configured to detect objects within the detection zone, and
a computer system comprising processing circuitry configured to trigger an action to stop rotation of the propeller (130, 330) in response to information from at least one of the plurality of proximity sensors (201, 202, 203, 204) indicating detection of an object within the detection zone of at least one of the plurality of proximity sensors (201, 202, 203, 204);
wherein the plurality of proximity sensors (201, 202, 203, 204) is arranged such that the detection zones of the plurality of proximity sensors (201, 202, 203, 204) enclose, preferably fully enclose, the propeller (130, 330) in a plane parallel to the longitudinal direction and the transversal direction.

Example 2: The safety system (100) according to Example 1, wherein each one of the detection zones has a conical shape extending between a sensor proximal end and a sensor distal end, wherein the plurality of proximity sensors (201, 202, 203, 204) is arranged such that the detection zones of the plurality of proximity sensors (201, 202, 203, 204) enclose, preferably fully enclose, the propeller (130, 330) in each plane, parallel to the longitudinal direction and the transversal direction, located at least from a lowermost to a uppermost point of the propeller (130, 330) along the vertical direction.

Example 3: The safety system (100) according to any one of Examples 1-2, wherein the marine vessel (1) further comprises a connecting member (101, 301) and a drive leg (305), the drive leg (305) comprising a central axis extending between the connecting member (101, 301) and the propeller (130, 330) along the vertical direction, wherein the plurality of proximity sensors (201, 202, 203, 204) is arranged about the central axis of the drive leg (305).

Example 4: The safety system (100) according to any one of Examples 1-3, wherein in the plane parallel to the longitudinal direction and the transversal direction, the detection zones of the proximity sensors (201, 202, 203, 204) form a continuous area (Z1) fully enclosing the propeller (130, 330).

Example 5: The safety system (100) according to any one of Examples 1-3, wherein the plurality of proximity sensors (201, 202, 203, 204) comprises at least four sensors located relative to the propeller (130, 330) such that lines (L1, L2, L3, L4) connecting adjacent sensors enclose the propeller (130, 330) in the plane parallel to the longitudinal direction and the transversal direction.

Example 6: The safety system (100) according to any one of the preceding Examples, wherein the safety system (100) further comprises a safety mechanism (150) configured to stop rotation of the propeller (130, 330), wherein the processing circuitry (402) is configured to cause the safety mechanism (150) to stop rotation of the propeller (130, 330) in response to information from at least one of the plurality of proximity sensors indicating detection of an object within the detection zone of at least one of the plurality of proximity sensors (201, 202, 203, 204).

Example 7: The safety system (100) according to Example 6, wherein the marine vessel (1) comprises a power source (140) for providing propulsion power to the propeller (130, 330), and wherein the safety system (100) comprises a power control device (160) configured to control a power supply to the power source (140), or alternatively control a power transfer from the power source (140) to the propeller (130, 330) via a transmission (120).

Example 8: The safety system (100) according to any one of the preceding Examples, wherein the plurality of proximity sensors (201, 202, 203, 204) comprises at least one of a sonar-based sensor, a radar-based sensor, a lidar-based sensor or a laser-based sensor.

Example 9: The safety system (100) according to any one of the proceeding Examples, further comprising:
a visual warning system (170) configured to generate a visible indication at a warning zone (Z2) being at a predetermined distance from the propeller (130, 330), wherein the warning zone (Z2) encloses, preferably fully enclose, the detection zones (Z1) of the proximity sensors (201, 202, 203, 204) and the propeller (130, 330) in the plane parallel to the longitudinal direction and the transversal direction.
wherein the processing circuitry (402) is further configured to cause the visual warning system (170) to generate the visible indication during operation of the propeller (130, 330).

Example 10: The safety system (100) according to Example 11, wherein the visual warning system (170) comprises a bubble generator (171), wherein the bubble generator comprises:
an air pressurization device,
a plurality of air nozzles arranged at the warning zone (Z2), and
a guiding device for guiding pressurized air to the plurality of air nozzles.

Example 11: The safety system (100) according to any one of the proceeding Examples, wherein the processing circuitry (402) is further configured to identify the detected object and determine whether the detected object is a forbidden object by inputting sensed data from the plurality of the proximity sensors (201, 202, 203, 204) to a machine-learning model.

Example 12: The safety system (100) according to Example 11, wherein the machine-learning model is trained using data collected by the plurality of the proximity sensors (201, 202, 203, 204).

Example 13: A propeller assembly for a marine vessel (1) comprising a connecting member (101, 301), a drive leg (305) and the safety system according to any one of the Examples 1-12, wherein the drive leg (305) comprises a central axis extending between the connecting member (101, 301) and the propeller (130, 330) along the vertical direction, wherein the connecting member (101, 301) is arranged to be articulately connected to a marine vessel's hull.

Example 14: The propeller assembly according to Example 13, wherein the connecting member (101, 301) has a horizontal extension in a connecting member plane being parallel to the longitudinal direction and the transversal direction, wherein the propeller (130, 330) has a horizontal extension in a propeller plane parallel to the longitudinal direction and the transversal direction, and wherein the horizontal extension of the connecting member (101, 301) is between 80%-150% of the horizontal extension of the propeller (130, 330).

Example 15: A marine vessel (1) comprising a safety system (100) according to any one of Examples 1-12 or a propeller assembly according to any one of Examples 13-14.

Example 16: A computer-implemented method for controlling a safety system (100) according to any one of Examples 1-12, comprising:
obtaining (S1), by the processing circuitry (402), information from at least one of the plurality of proximity sensors (201, 202, 203, 204) indicating detection of an object within the detection zone of at least one of the plurality of proximity sensors (201, 202, 203, 204), and
in response thereto, triggering (S2), by the processing circuitry (402), an action to stop rotation of the propeller (130, 330).

Example 17: The method according to Example 16, wherein the processing circuitry (402) is further configured to identify the detected object and determine whether the detected object is a forbidden object by inputting sensed data by the plurality of the proximity sensors to a machine-learning model, wherein the feature of triggering an action to stop rotation of the propeller comprises:
determining (S3), by the processing circuitry (402), whether the detected object is a forbidden object using the machine learning model, and
initiating (S4), by the processing circuitry (402), the action to stop rotation of the propeller (130, 330) in response to determining that the detected object is a forbidden object.

Example 18: The method according to Example 16 or Example 17, wherein the safety system (100) further comprising:
a visual warning system (170) configured to generate a visible indication at a warning zone being at a predetermined distance from the propeller (130, 330), wherein the warning zone encloses, preferably fully enclose, the detection zones of the proximity sensors (201, 202, 203, 204) and the propeller (130, 330) in a plane parallel to the longitudinal direction and the transversal direction.
   wherein the method further comprising:
in response to determining that the propeller (130, 330) starts to rotate, controlling (S5), by the processing circuitry (402), the visual warning system (170) to generate a visible indication at the warning zone (Z2).

Example 19: A computer program product comprising program code for performing, when executed by the processing circuitry, the method according to Examples 16-18.

Example 20: A non-transitory computer-readable storage medium comprising instructions, which when executed by the processing circuitry, cause the processing circuitry to perform the method according to Examples 16-18.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A safety system for a marine vessel, the marine vessel having a longitudinal extension in a longitudinal direction being parallel to an intended direction of travel of the marine vessel, the marine vessel further having a vertical extension in a vertical direction extending upwards perpendicular to a still water surface when the marine vessel is located in a body of water, the marine vessel also having a transversal extension in a transversal direction being perpendicular to each one of the longitudinal direction and the vertical direction, the marine vessel comprising at least one propeller arranged to rotate in the water to provide propelling force to the marine vessel during operation, the safety system comprising:
a plurality of proximity sensors, each proximity sensor having a detection zone and configured to detect objects within the detection zone, and
a computer system comprising processing circuitry configured to trigger an action to stop rotation of the propeller in response to information from at least one of the plurality of proximity sensors indicating detection of an object within the detection zone of at least one of the plurality of proximity sensors;
wherein the plurality of proximity sensors is arranged such that the detection zones of the plurality of proximity sensors enclose the propeller in a plane parallel to the longitudinal direction and the transversal direction.

2. The safety system according to claim 1, wherein each one of the detection zones has a conical shape extending between a sensor proximal end and a sensor distal end, wherein the plurality of proximity sensors is arranged such that the detection zones of the plurality of proximity sensors enclose, the propeller in each plane, parallel to the longitudinal direction and the transversal direction, located at least from a lowermost to a uppermost point of the propeller along the vertical direction.

3. The safety system according to claim 1, wherein the marine vessel further comprises a connecting member and a drive leg, the drive leg comprising a central axis extending between the connecting member and the propeller along the vertical direction, wherein the plurality of proximity sensors is arranged about the central axis of the drive leg.

4. The safety system according to claim 1, wherein in the plane parallel to the longitudinal direction and the transversal direction, the detection zones of the proximity sensors form a continuous area fully enclosing the propeller.

5. The safety system according to claim 1, wherein the plurality of proximity sensors comprises at least four sensors located relative to the propeller such that lines connecting adjacent sensors enclose the propeller in the plane parallel to the longitudinal direction and the transversal direction.

6. The safety system according to claim 1, wherein the safety system further comprises a safety mechanism configured to stop rotation of the propeller, wherein the processing circuitry is configured to cause the safety mechanism to stop rotation of the propeller in response to information from at least one of the plurality of proximity sensors indicating detection of an object within the detection zone of at least one of the plurality of proximity sensors.

7. The safety system according to claim 1, wherein the plurality of proximity sensors comprises at least one of a sonar-based sensor, a radar-based sensor, a lidar-based sensor or a laser-based sensor.

8. The safety system according to claim 1, further comprising:
a visual warning system configured to generate a visible indication at a warning zone being at a predetermined distance from the propeller, wherein the warning zone encloses, the detection zones of the proximity sensors and the propeller in the plane parallel to the longitudinal direction and the transversal direction,
wherein the processing circuitry is further configured to cause the visual warning system to generate the visible indication during operation of the propeller.

9. The safety system according to claim 1, wherein the processing circuitry is further configured to identify the detected object and determine whether the detected object is a forbidden object by inputting sensed data from the plurality of the proximity sensors to a machine-learning model.

10. A propeller assembly for a marine vessel comprising a connecting member, a drive leg and the safety system according to claim 1, wherein the drive leg comprises a central axis extending between the connecting member and the propeller along the vertical direction, wherein the connecting member is arranged to be articulately connected to a marine vessel's hull.

11. The propeller assembly according to claim 10, wherein the connecting member has a horizontal extension in a connecting member plane being parallel to the longitudinal direction and the transversal direction, wherein the propeller has a horizontal extension in a propeller plane parallel to the longitudinal direction and the transversal direction, and wherein the horizontal extension of the connecting member is between 80%-150% of the horizontal extension of the propeller.

12. A marine vessel comprising a safety system according to claim 1.

13. A marine vessel comprising a propeller assembly according to claim 10.

14. A computer-implemented method for controlling a safety system according to claim 1, comprising:
obtaining, by the processing circuitry, information from at least one of the plurality of proximity sensors indicating detection of an object within the detection zone of at least one of the plurality of proximity sensors, and
in response thereto, triggering, by the processing circuitry, an action to stop rotation of the propeller.

15. A computer program product comprising program code for performing, when executed by the processing circuitry, the method according to claim 14.

16. A non-transitory computer-readable storage medium comprising instructions, which when executed by the processing circuitry, cause the processing circuitry to perform the method according to claim 14.
